(19) United States
(12) Patent Application Publication
(10) Pub. No.: US 2022/0308822 A1
(43) Pub. Date: Sep. 29, 2022

(54) WIERLESS SCREEN MIRRORING METHOD AND DEVICE BASED ON IP NETWORK CONNECTION

(71) Applicant: SHENZHEN MENBORDER TECHNOLOGY CO., LTD, SHENZHEN (CN)

(72) Inventor: FEI XU, SHENZHEN (CN)

(21) Appl. No.: 17/211,857

(22) Filed: Mar. 25, 2021

(51) Int. Cl. G06F 3/14; H04W 76/10; H04W 12/50

(52) U.S. Cl. CPC G06F 3/1454; H04W 76/10; H04W 12/50; H04W 80/06

(57) ABSTRACT

The present disclosure provides a wireless screen mirroring method based on IP network connection. The method applied to a screen projection receiving and sending device includes: broadcasting a Wi-Fi beacon based on the Wi-Fi direct connection protocol, detecting the Wi-Fi beacon from the receiving device, sending a Wi-Fi detection request to the receiving device, receiving and responding to the detection request, sending a connection information for establishing a handshake used to establish an RTSP connection and complete the Miracast handshake protocol to the sending device, the sending device gets connection information, according to the connection information for establishing a handshake, analyzing the information and sending alarm information used to indicate that the receiving device has completed the connection. The present disclosure combines the advantages of network connection, wired network and Miracast standard to realize a more stable screen projection method based on wired network or wireless network.

### BACKGROUND

### Field

The present disclosure relates in general to wireless screen projection, and more particularly to a wireless screen mirroring method based on IP network connection.

### Description of the Related Art

screen projection refers to the technology of projecting content from one device to another device for display. In the scenes of screen projection, most of them are “small screens” projected onto “big screens”. For example, smart phones or tablet PCs are projected onto computers or TVs, etc.

At present, there are mainly several ways of wireless screen mirroring: 1. Miracast wireless screen mirroring achieving low-latency wireless screen mirroring has the limit in that it can only use Wi-Fi direct technology resulting in the stability and reliability of the connection cannot be effectively guaranteed in many cases; 2. Airplay wireless screen mirroring; 3. Google cast wireless screen mirroring. Both Airplay and Google cast are capable of achieving network-based screen mirroring. The original intention of these two methods is not for wireless screen minoring, but is similar to DLNA technology allowing wireless receiving devices to get the specified network video content through the Internet. Therefore, when these two methods are used for screen mirroring, the smoothness and delay of the video cannot be handled well.

### SUMMARY

In order to solve the above problems, the present disclosure provides a wireless screen mirroring method based on IP network connection.

On the one hand, the present disclosure provides a wireless screen mirroring method based on IP network connection applied to a screen projection receiving device, including:

broadcasting a Wi-Fi beacon to a screen projection sending device, the Wi-Fi beacon includes the IP address and configuration information of the machine;

getting a Wi-Fi detection request sent by the screen projection sending device, where the Wi-Fi detection request is sent when the screen projection sending device receives the Wi-Fi beacon;

responding to the Wi-Fi detection request and sending connection information for establishing a handshake to the screen projection sending device, where the connection information for establishing a handshake is used to establish an RTSP connection and complete the Miracast handshake protocol.

Preferably, further including the steps of encrypting the connection information for establishing a handshake, and the steps of encrypting the connection information for establishing a handshake include:

establishing an encrypted secure connection, where the process of the encrypted secure connection adopts the SSL standard protocol to complete key interaction;

getting the standard DTLS connect information initiated by the screen projection sending device after the key interaction is completed;

performing PIN code interaction with the screen projection sending device according to the standard DTLS connection information.

On the one hand, the present disclosure provides a wireless screen mirroring method based on IP network connection applied to a screen projection sending device, including:

getting a Wi-Fi beacon broadcast by a screen projection receiving device and extracting the IP address and configuration information in the Wi-Fi beacon;

sending a Wi-Fi detection request to the screen projection receiving device according to the IP address and configuration information;

getting connection information for establishing a handshake sent by the screen projection receiving device, where the connection information for establishing a handshake is sent when the screen projection receiving device responds to the Wi-Fi detection request;

analyzing the information and sending alarm information, according to the connection information for establishing a handshake, where the alarm information is used to indicate that the screen projection receiving device has completed the connection.

Preferably, further including the following steps before sending the alarm information:

sending connection information to a TCP port 7380 of the screen projection receiving device;

getting response information for establishing a connection with the TCP port 7380 of the screen projection receiving device;

sending a service request to the screen projection receiving device and performing encryption negotiation, according to the response information, where the process of the encryption negotiation adopts the SSL standard protocol to complete key interaction;

sending the standard DTLS connection information to the screen projection sending device, where the standard DTLS connection information is sent after the screen projection sending device receives a key interaction completed by the screen projection receiving device.

On the one hand, the present disclosure provides a wireless screen mirroring method based on IP network connection applied to a screen projection receiving device and a screen projection sending device, including:

the screen projection receiving device broadcasts a Wi-Fi beacon based on the Wi-Fi direct connection protocol;

the screen projection sending device detects the Wi-Fi beacon broadcast by the screen projection receiving device and sends a Wi-Fi detection request to the screen projection receiving device;

the screen projection receiving device receives the Wi-Fi detection request, responds to the Wi-Fi detection request and sends connection information for establishing a handshake to the screen projection sending device, where the connection information for establishing a handshake is used to establish an RTSP connection and complete the Miracast handshake protocol;

the screen projection sending device gets the connection information for establishing a handshake, according to the connection information for establishing a handshake, analyzes the information and sends alarm information, where the alarm information is used to indicate that the screen projection receiving device has completed the connection.

It should be understood that the above general description and the following detailed description are merely exemplary and explanatory, and cannot limit the scope of protection of the present disclosure.

Compared with the prior art, the present disclosure provides a wireless screen mirroring method based on IP network connection. The present disclosure organically combines the advantages of network connection, wired network and Miracast standard to achieve fast screen connection, reliable screen connection and low-latency screen mirroring.

Obviously, the above description of the advantages of the present disclosure is general, and more descriptions of advantages will be reflected in the subsequent embodiment disclosures. Those skilled in the art can also reasonably discover many other advantages of the present disclosure based on the contents disclosed in the present disclosure.

The additional aspects and advantages of the present disclosure will be given in the following description, and the advantages of the present disclosure will become apparent in the following description or be understood through the practice of the present disclosure.

### BRIEF DESCRIPTION OF THE FIGURES

FIG. 1 is a flow chart of an IP network connection, according to embodiments of the present disclosure;

FIG. 2 is a flow chart of the wireless screen mirroring method applied to a screen projection receiving device, according to embodiments of the present disclosure;

FIG. 3 is a flow chart of the connection of the device, according to embodiments of the present disclosure,

FIG. 4 is a flow chart of the wireless screen mirroring method applied to a screen projection sending device, according to embodiments of the present disclosure;

FIG. 5 is a flow chart of the wireless screen mirroring method applied to a screen projection sending device and a screen projection receiving device, according to embodiments of the present disclosure;

FIG. 6 is a flow chart of a wireless screen mirroring method based on IP network connection, according to embodiments of the present disclosure.

### DETAILED DESCRIPTION

Reference will now he made in detail to the current embodiments of the present disclosure, examples of which are illustrated in the drawings. Whenever possible, the same component symbols are used in the drawings and descriptions to indicate the same or similar parts.

In the exemplary embodiment of the present disclosure, the solution mainly involves the process of constructing a screen connection by a screen projection sending device, a screen projection receiving device and an Ethernet switch or Wi-Fi router. The screen projection receiving device refers to the terminal device used to share the screen with the screen projection sending device, preferably a mobile phone, a notebook computer, a tablet computer, a POS machine, a vehicle-mounted computer, etc. In the present disclosure, the screen projection receiving device performs wireless or wired communication with the screen projection sending device and receives audio and video information from the screen projection sending device, so as to realize screen sharing with the screen projection sending device.

It should be noted that the illustrations provided in the following embodiments are only illustrative to illustrate the basic idea of the present disclosure. The drawings only show the components related to the present disclosure, instead of drawing according to the number, shape and size of the components in actual implementation. In actual implementation, the type, quantity, and ratio of each component can be changed at will, and the component layout type may be more complicated.

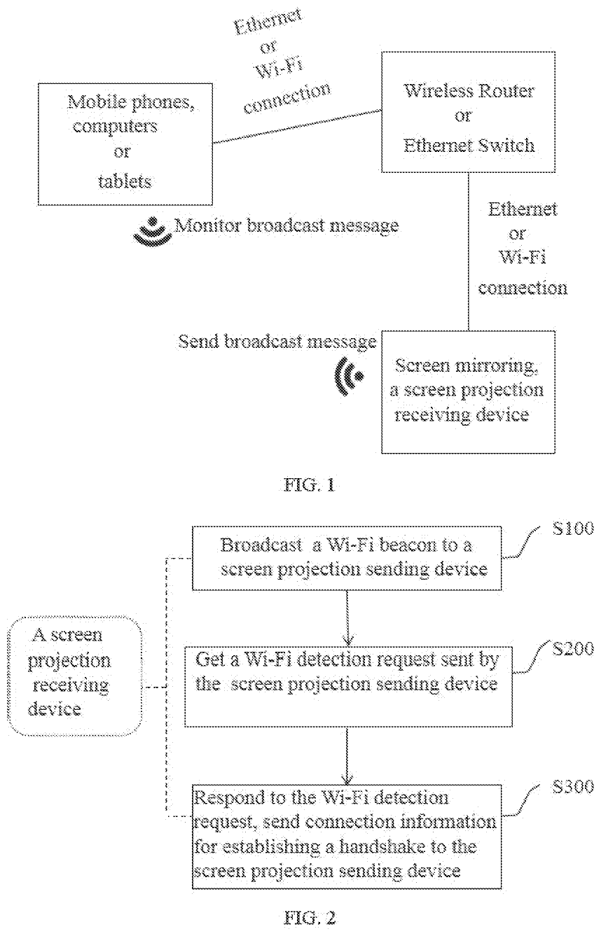

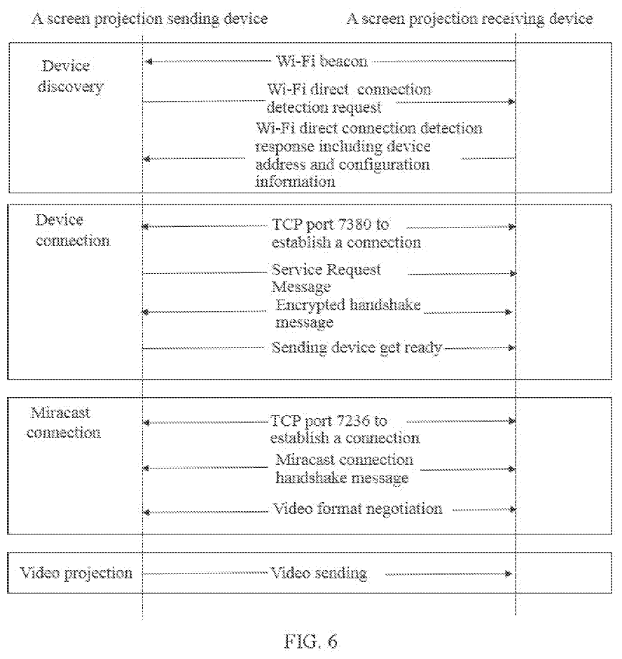

FIG. 1-FIG. 6 are flow charts of a wireless screen mirroring method based on IP network connection provided by the embodiments of the present disclosure.

Specifically, when the wireless screen mirroring method based on IP network connection is applied to a screen projection receiving device, as shown in FIG. 2, including:

S100: broadcasting a Wi-Fi beacon to a screen projection sending device, where the Wi-Fi beacon includes the IP address and configuration information of the machine;

S200: getting a Wi-Fi detection request sent by the screen projection sending device, where the Wi-Fi detection request is sent when the screen projection sending device receives the broadcast Wi-Fi beacon.

S300: responding to the Wi-Fi detection request and sending connection information for establishing a handshake to the screen projection sending device, where the connection information for establishing a handshake is used to establish an RTSP connection and complete the Miracast handshake protocol.

As shown in FIG. 1, a screen projection sending device (such as mobile phone, computer or tablet) and a screen projection receiving device (TV, computer) are connected through a wireless router or an Ethernet switch network (Ethernet or Wi-Fi). For mobile devices such as computers or mobile phones, they are usually connected to a wireless router or a wired Ethernet in an indoor environment ensuring the applicability of the present disclosure.

The screen projection sending device and the screen projection receiving device get the surrounding network information in two ways: one is passive scanning, where the screen projection sending device or the screen projection receiving device simply monitors a Wi-Fi beacon frame sent by the surrounding device to get network information; the other is active scanning, where the screen projection sending device or the screen projection receiving device actively sends a detection request frame at the same time while scanning, and gets network signals by receiving the detection respond frame.

Taking the passive scanning mode as an example, the screen projection receiving device will periodically broadcast Wi-Fi beacons and mark in the Wi-Fi beacon that the screen projection receiving device supports Wi-Fi direct connection. It is understandable that the literal meaning of “beacon” is that the screen projection receiving device periodically sends data packets at a certain time interval, and the sent data can be got by devices such as mobile phones. The screen projection sending device actively sends a Wi-Fi detection request after detecting this beacon. The screen projection receiving device will reply with detection respond information after receiving the detection request from the screen projection sending device. The detection respond information contains the device extension information of the screen projection receiving device. Alternatively, the device extension information includes at least: IP address, device name, configuration information, and whether network projection is supported.

In the above-mentioned embodiments, the present disclosure also follows the connection process defined by the Miracast standard protocol. No matter whether the screen projection sending device or the screen projection receiving device supports this solution, the device can finally complete the Miracast protocol handshake and successfully cast the screen. Compared with the prior art, the present disclosure adopts the Wi-Fi direct connection broadcast information mechanism, combines the stable and reliable advantages of IP network connection and the Low latency advantage of Miracast technology to achieve rapid connection, reliable connection and Low latency screen mirroring.

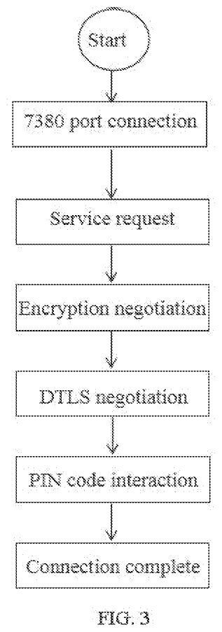

Further conversion, as shown in FIG. 3, the present disclosure further includes the steps of encrypting the connection information for establishing a handshake including:

establishing an encrypted secure connection, where the process of the encrypted secure connection adopts the SSL standard protocol to complete key interaction;

getting the standard DTLS connection information initiated by the screen projection sending device after the key interaction is completed;

Performing PIN code interaction with the screen projection sending device according to the standard DTLS connection information.

FIG. 3 and FIG. 6 of this implementation scenario are also relate to the connection of the device. The connection of the device is used to establish a secure and encrypted connection between the screen projection sending/receiving devices to ensure the security of video data. A screen projection sending device sends connection information to a TCP port 7380 of a screen projection receiving device through the obtained IP address. After the port connection is established, the screen projection sending device sends a service request to the screen projection receiving device and starts encryption negotiation. The process of the encryption negotiation uses the SSL standard protocol to complete key interaction. After the key interaction is completed, the screen projection sending device continues to initiate the standard DTLS negotiation and complete the PIN code interaction.

In SSL, the actual data transmission is achieved by using the SSL record protocol. The SSL record protocol works by dividing the data stream into a series of fragments and transmitting them, where each fragment is protected and transmitted separately. The receiver (that is, the screen projection receiving device) decrypts and verifies each record separately. This scheme allows data to be transmitted from one end of the connection to the other as soon as it is ready and processed as soon as it is received.

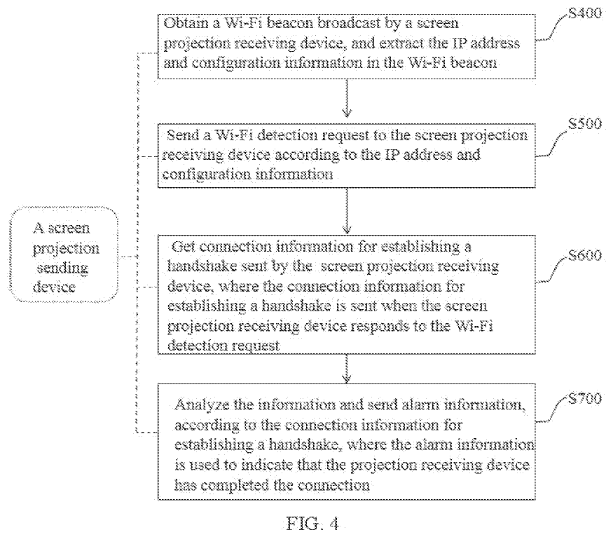

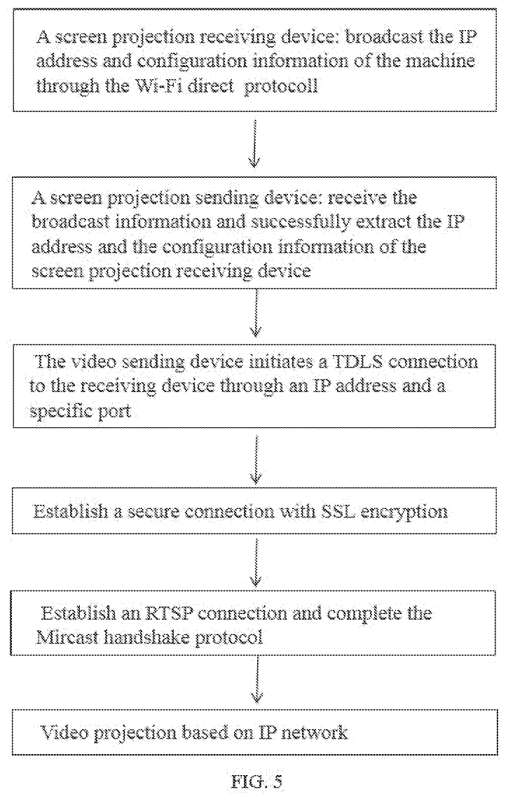

Specifically, when the wireless screen mirroring method based on IP network connection is applied to a screen projection sending device, as shown in FIG. 4, including:

S400: getting a Wi-Fi beacon broadcast by a screen projection receiving device and extracting the IP address and configuration information in the Wi-Fi beacon;

S500: sending a Wi-Fi detection request to the screen projection receiving device according to the IP address and configuration information;

S600: getting connection information for establishing a handshake sent by the screen projection receiving device, where the connection information for establishing a handshake is sent when the screen projection receiving device responds to the Wi-Fi detection request;

S700: analyzing the information and sending alarm information, according to the connection information for establishing a handshake, where the alarm information is used to indicate that the screen projection receiving device has completed the connection.

Further conversion, the following steps are also included before sending the alarm information:

sending connection information to a TCP port 7380 of the screen projection receiving device;

getting response information for establishing a connection with the TCP port 7380 of the screen projection receiving device;

sending a service request to the screen projection receiving device and performing encryption negotiation, according to the respond information for establishing a connection with the TCP port 7380 of the screen projection receiving device, where the process of the encryption negotiation adopts the SSL standard protocol to complete key interaction;

sending the standard DTLS connection information to the screen projection sending device, where the standard DTLS connection information is sent after the screen projection sending device receives a key interaction completed by the screen projection receiving device.

For ease of description, a wireless screen mirroring method is divided into a functional module architecture, and the method includes a screen projection receiving device, where the screen projection receiving device includes:

A first sending module for broadcasting a Wi-Fi beacon to a screen projection sending device, where the Wi-Fi beacon includes the IP address and configuration information of the machine;

A first getting module for getting a Wi-Fi detection request sent by the screen projection sending device, where the Wi-Fi detection request is sent when the projection sending device receives the Wi-Fi beacon;

A first connection module for responding to the Wi-Fi detection request and sending connection information for establishing a handshake to the screen projection sending device, where the connection information for a handshake is used to establish an RTSP connection and complete the Miracast handshake protocol.

For ease of description, a wireless screen minoring method is divided into a functional module architecture, and the method includes a projection sending device, where the screen projection sending device includes:

A second getting module a for getting a Wi-Fi beacon broadcast by a screen projection receiving device and extracting the IP address and configuration information in the Wi-Fi beacon;

A second sending module for sending a Wi-Fi detection request to the screen projection receiving device according to the IP address and configuration information;

A second getting module b for getting connection information for establishing a handshake sent by the screen projection receiving device, where the connection information for establishing a handshake is sent when the screen projection receiving device responds to the Wi-Fi detection request;

An alarm module for analyzing the information and sending alarm information, according to the connection information for establishing a handshake, where the alarm information is used to indicate that the screen projection receiving device has completed the connection.

The present disclosure is not limited to the above-mentioned embodiments, as long as the solutions mentioned in the specification fall within the protection scope of the present disclosure.

The above embodiments adopt specific examples to illustrate the present disclosure, which are only used to help understand the present disclosure and not to limit the present disclosure. For those skilled in the art to, based on the idea of the present disclosure, several simple deductions, modifications or substitutions can also be made, which shall he fall within the scope of the present disclosure.

1. A wireless screen mirroring method based on IP network connection applied to a screen projection receiving device includes:
broadcasting a Wi-Fi beacon to a screen projection sending device, wherein the Wi-Fi beacon includes the IP address and configuration information of the machine;
getting a Wi-Fi detection request sent by the screen projection sending device, wherein the Wi-Fi detection request is sent when the screen projection sending device receives the Wi-Fi beacon;
responding to the Wi-Fi detection request and sending connection information for establishing a handshake to the screen projection sending device, wherein the connection information for establishing a handshake is used to establish an RTSP connection and complete the Miracast handshake protocol.

2. The method of claim 1, wherein further including the steps of encrypting the connection information for establishing a handshake, and the step of encrypting the connection information for establishing a handshake includes:
establishing an encrypted secure connection, wherein the process of the encrypted secure connection process adopts the SSL standard protocol to complete key interaction;
getting the standard DTLS connect information initiated by the screen projection sending device after the key interaction is completed;
performing PIN code interaction with the screen projection sending device according to the standard DTLS connection information.

3. A wireless screen mirroring method based on IP network connection applied to a screen projection sending device includes:
getting a Wi-Fi beacon broadcast by a screen projection receiving device and extracting the IP address and configuration information in the Wi-Fi beacon;
sending a Wi-Fi detection request to the screen projection receiving device according to the IP address and configuration information;
getting connection information for establishing a handshake sent by the screen projection receiving device, wherein the connection information for establishing a handshake is sent when the screen projection receiving device responds to the detection request;
analyzing the information and sending alarm information, according to the connection information for establishing a handshake, wherein the alarm information is used to indicate that the screen projection receiving device has completed the connection.

4. The method of claim 3, wherein further including the following steps before sending the alarm information:
sending connection information to a TCP port 7380 of the screen projection receiving device;
getting response information for establishing a connection with the TCP port 7380 of the screen projection receiving device;
sending a service request to the screen projection receiving device and performing encryption negotiation, according to the respond information, wherein the encryption negotiation process adopts the SSL standard protocol to complete key interaction;
sending the standard DTLS connection information to the screen projection sending device, wherein the standard DTLS connection information is sent after the screen projection sending device receives a key interaction completed by the screen projection receiving device.

5. A wireless screen mirroring method based on IP network connection applied to a screen projection sending device and a screen projection sending device includes:
the screen projection receiving device broadcasts a Wi-Fi beacon based on the Wi-Fi direct connection protocol;
the screen projection sending device detects the Wi-Fi beacon broadcast by the screen projection receiving device and sends a Wi-Fi detection request to the screen projection receiving device;
the screen projection receiving device receives the Wi-Fi detection request, responds to the Wi-Fi detection request and sends connection information for establishing a handshake to the screen projection sending device, wherein the connection information for establishing a handshake is used for establishing an RTSP connection and completing the Miracast handshake protocol;
the screen projection sending device gets the connection information for establishing a handshake, according to the connection information for establishing a handshake, analyzes the information and sends alarm information, wherein the alarm information is used to indicate that the screen projection receiving device has completed the connection.
